(19) United States
(12) Patent Application Publication
(10) Pub. No.: US 2024/0019399 A1
(43) Pub. Date: Jan. 18, 2024

(54) Monitoring System Of Crack Propagation Of Underwater Structure Visual Based on Alternating Current Field, and Alternating Current Field Crack Visual Monitoring and Evaluation method

(71) Applicant: CHINA UNIVERSITY OF PETROLEUM, (US)

(72) Inventors: Xin'an YUAN, Qingdao, Shandong (CN); Wei LI, Qingdao, Shandong (CN); Guoming CHEN, Qingdao, Shandong (CN); Xiaokang YIN, Qingdao, Shandong (CN); Xiao LI, Qingdao, Shandong (CN); Jianming ZHAO, Qingdao, Shandong (CN); Jianchao ZHAO, Qingdao, Shandong (CN)

(21) Appl. No.: 18/025,188

(22) PCT Filed: Jun. 28, 2022
(86) PCT No.: PCT/CN2022/102039

§ 371 Date: Mar. 8, 2023

(30) Foreign Application Priority Data
Jul. 8, 2021 (CN) 202110772687.0
Jul. 8, 2021 (CN) 202110772811.3

(51) Int. Cl. G01N 27/82

(52) U.S. Cl. CPC G01N 27/82

(57) ABSTRACT

The present disclosure discloses a visual monitoring system of crack propagation of an underwater structure based on an alternating current field, and an alternating current field crack visual monitoring and evaluation method. The method includes that: a coil is used to design and manufacture an alternating current field monitoring sensor array, n alternating current field monitoring sensor component is formed by packaging, a power amplifier component is designed to provide an excitation signal for the alternating current field monitoring sensor component, a differential amplifier component is designed to amplify a weak sensing signal, a multiplexing component is designed to realize time-sharing multiplexing of multiple sensing signals, a signal amplification and filtering component is designed to further amplify and filter the signal, a wave detection component is designed to convert an AC signal into a DC signal, and excitation signal generation, multiplexing control signal output and signal acquisition are realized.

### CROSS-REFERENCE TO RELATED APPLICATION

The present disclosure claims priority of Chinese Patent Application No. 202110772811.3, filed to the China National Intellectual Property Administration on Jul. 8, 2021 and entitled “Alternating Current Field Crack Visual Monitoring and Evaluation Method”, and Chinese Patent Application No. 202110772687.0, filed on Jul. 8, 2021 and entitled “Structure Crack Propagation Visual Monitoring System Based on Alternating Current Field”, the disclosures of which are hereby incorporated by reference in their entirety.

### TECHNICAL FIELD

The present disclosure relates to the technical field of structural health monitoring, in particular to a visual monitoring system of crack propagation of an underwater structure based on an alternating current field, and an alternating current field crack visual monitoring and evaluation method.

### BACKGROUND

Marine structures have been in service in a seawater environment for a long time, and due to the corrosion of seawater, the structure surface is prone to various corrosion defects. Due to the factors such as coating coverage and attachment accumulation, a conventional nondestructive testing technology needs to detect and evaluate the defects in the underwater structure detection process in a case of cleaning attachments in a large area and completely destroying a coating. The operation process is complicated, the efficiency is low, and the structure surface cleaning and coating repair costs are high. Especially in deep water areas, the interval between routine detection operations is long, resulting in missed detection of primary initiation cracks.

An alternating Current Field Measurement (ACFM) technology is a new electromagnetic nondestructive testing technology, which is mainly configured for surface crack detection of a conductive material, and uses a uniform current induced by a detection probe on the surface of a conductive specimen. The current generates the disturbance around the defect to cause the distortion of a spatial magnetic field, and the defect detection and evaluation are performed by measuring the distorted magnetic field. When there are no defects, the current on the surface of the conductive specimen is in a uniform state, and the spatial magnetic field is not disturbed. Due to the advantages of non-contact measurement and quantitative evaluation, the technology is widely applied to detection of various marine structure detects. The existing ACFM technology determines the defects according to characteristic signals Bx and Bz and a butterfly diagram, where Bx and Bz signals are magnetic field signals parallel to the surface of the specimen (parallel to the scanning direction of the probe) and perpendicular to the surface of the specimen respectively. The characteristic signal Bx may evaluate the crack depth, and the characteristic signal Bz may evaluate the crack length.

A probe of a conventional ACFM system is of a three-dimensional shell structure, which may not adapt to the attachment of key nodes of the structure. At the same time, sensors are also arranged at a single point or in a linear array, which may not realize area crack monitoring. An ACFM hardware system is suitable for signal processing of sensors in a single array or few arrays, which may not meet large-scale monitoring sensor signal acquisition and processing. In addition, conventional Bx and Bz amplitude characteristic signals may not display crack propagation endpoint and edge images, which may not meet the requirements for real-time visual monitoring.

### SUMMARY

In a typical embodiment of the present disclosure, a visual monitoring system of crack propagation of an underwater structure based on an alternating current field is provided, which include: a sensor component for monitoring flexible alternating current magnetic field closely attached to a monitored surface, an alternating current field monitor, a Universal Serial Bus (USB) data cable, and a computer, the sensor component for monitoring flexible alternating current magnetic field includes a flexible Printed Circuit Board (PCB) excitation component and a flexible monitoring sensor array, the alternating current field monitor including a signal conditioning component, a signal acquisition component, a power amplifier component, and a voltage regulator component, and the computer is connected with the signal acquisition component in the alternating current field monitor through the USB data cable.

In some embodiments, the flexible PCB excitation component adopts M (M≥1) layers of double rectangular sensor coils printed on a flexible substrate, the double rectangular sensor coils are loaded with excitation signals in different directions respectively, the flexible monitoring sensor array include a flexible planar PCB component and m rows and n columns of sensor coils fixed on the flexible planar PCB component, outer diameter of the sensor coil is D (D<10 mm), the inner diameter is d (d<D), the number of turns of the sensor coil is N, axis of the sensor coil is perpendicular to the flexible planar PCB component, center distance between the two adjacent sensor coils is 3 mm-20 mm, and the sensor coil maybe replaced by a magnetic field sensor.

In some embodiments, the voltage regulator component is respectively connected with the signal conditioning component, the signal acquisition component, and the power amplifier component, the flexible PCB excitation component is connected with an output end of the power amplifier component, and an input end of the power amplifier component is connected with an analog signal output end of the signal acquisition component.

In some embodiments, the signal conditioning component includes an AD620 differential amplifier component, a multiplexing component, an amplification and filtering component, and a wave detection component, a input end of the AD620 differential amplifier component is connected with the sensor coil, a signal input end of the multiplexing component is connected with a signal output end of the AD620 differential amplifier component, a control signal input end of the multiplexing component is connected with a digital signal output end of the signal acquisition component, a signal output end of the multiplexing component is connected with a signal input end of the amplification and filtering component, a signal output end of the amplification and filtering component is connected with a signal input end of the wave detection component, and a signal output end of the wave detection component is connected with an analog signal input end of the signal acquisition component.

An embodiment of the present disclosure provides a structure crack visual monitoring and evaluation method based on an ACFM technology, which may include the following operations.

A uniform induced current is generated on the surface of a specimen through a PCB excitation component to cause a distortion of a spatial magnetic field, a flexible monitoring sensor array composed of m rows and n columns of coils is placed on the surface of the specimen to extract a matrix

$$A 0 = [ \begin{matrix}Bz {0}_{11} & ⋯ & Bz \text{?} \\ ⋮ & ⋱ & \text{?} \\ Bz {0}_{m 1} & ⋯ & Bz \text{?}\end{matrix} ]$$

$$\text{?} \text{indicates text missing or illegible when filed}$$

of current magnetic field signals Bz0 in the Z direction at a initial moment of a monitoring area, a matrix

$$A = [ \begin{matrix}{Bz}_{11} & ⋯ & B \text{?} \\ ⋮ & ⋱ & ⋮ \\ {Bz}_{m 1} & ⋯ & B \text{?}\end{matrix} ]$$

$$\text{?} \text{indicates text missing or illegible when filed}$$

of real-time magnetic field signals Bz in the Z direction of the surface of the specimen is acquired in real time over time, the matrix A is linearly interpolated and an intensity map is drawn to obtain a visual image for monitoring of cracks at key nodes of a structure.

A position (x1, y1) of a largest element and a position (x2, y2) of a second largest element of the matrix A are obtained, p×q element values centered at (x1, y1) and positions thereof are extracted as data of group a, and nine element values centered at (x2, y2) and positions thereof are extracted as data of group b.

Signal centroids of the data of the group a and the data of the group b are obtained respectively according to formulas

$$\overline{x} = \frac{\sum xi \times Bz}{\sum Bz} and \overline{y} = \frac{\sum yi \times Bz}{\sum Bz} .$$

Xi is X-coordinate positions of nine elements, yi is Y-coordinate positions of nine elements, two endpoint coordinates (xa, ya) and (xb, yb) of a crack are obtained, and length of the crack is calculated by a distance between the two endpoint coordinates.

A signal increment matrix

$$C = [ \begin{matrix}{dBz}_{11} & ⋯ & dB \text{?} \\ ⋮ & ⋱ & ⋮ \\ {dBz}_{m 1} & ⋯ & dB \text{?}\end{matrix} ]$$

$$\text{?} \text{indicates text missing or illegible when filed}$$

is obtained by subtracting the matrix A0 from the matrix A.

An energy value E0 of the matrix A0 and an energy value Ec of the signal increment matrix C are obtained according to a formula

$${E}_{dBz} = {\sum }_{j = 1}^{m \times n} dBz \text{?} .$$

$$\text{?} \text{indicates text missing or illegible when filed}$$

and a ratio of Ec to E0 is calculated to obtain an energy distortion rate ΔE.

The energy distortion rate ΔE is compared with a set energy threshold N, in a case that ΔE>N, the crack has propagated.

In a case that ΔE≤N, determined that the crack has not propagated, and the elements in the signal increment matrix C are compared with a set noise threshold N1, and in a case that the elements in the signal increment matrix C<N1, the crack is in length propagation, in a case that the elements in the signal increment matrix C≥N1, the crack is in depth propagation.

### BRIEF DESCRIPTION OF THE DRAWINGS

FIG. 1 is a system block diagram according to an embodiment of the present disclosure.

FIG. 2 is a sensor component for monitoring flexible alternating current magnetic field according to an embodiment of the present disclosure.

FIG. 3 is an alternating current field monitor according to an embodiment of the present disclosure.

FIG. 4 is a flexible PCB excitation component according to an embodiment of the present disclosure.

FIG. 5 is a flexible monitoring sensor array according to an embodiment of the present disclosure.

FIG. 6 is an alternating current field monitoring hardware system according to an embodiment of the present disclosure.

FIG. 7 is a crack visual monitoring image according to an embodiment of the present disclosure.

FIG. 8 is a flowchart of an alternating current field defect on-line intelligent determination and classification recognition method according to an embodiment of the present disclosure.

FIG. 9 is an alternating current field monitoring sensor array according to an embodiment of the present disclosure.

FIG. 10 is a visual image for structure crack monitoring according to an embodiment of the present disclosure.

FIG. 11 is a schematic diagram of matrix element grouping according to an embodiment of the present disclosure.

FIG. 12 is a schematic diagram of crack depth propagation monitoring according to an embodiment of the present disclosure.

FIG. 13 is a schematic diagram of crack length propagation monitoring according to an embodiment of the present disclosure.

In the above figures: 1. Computer; 2. USB data cable; 3. Alternating current field monitor; 3.1. Signal conditioning component; 3.1.1. AD620 differential amplifier component; 3.1.2 Multiplexing component; 3.1.3. Amplification and filtering component; 3.1.4. Wave detection component; 3.2. Signal acquisition component; 3.3. Voltage regulator component; 3.4. Power amplifier component; 4. Sensor component for monitoring flexible alternating current magnetic field; 4.1. Flexible PCB excitation component; 4.2. Flexible monitoring sensor array.

### DETAILED DESCRIPTION OF THE EMBODIMENTS

The present disclosure is further described in combination with the accompanying drawings 1-13.

In order to make the purposes, technical solutions and advantages of the present disclosure clearer, the present disclosure will be further described below in combination with the accompanying drawings and specific embodiments. It is apparent that the described embodiments are only a part of the embodiments of the present disclosure, and not all of them. All other embodiments obtained by those skilled in the art based on the embodiments of the present disclosure without creative efforts shall fall within the scope of protection of the present disclosure.

It is to be noted that the embodiments of the present disclosure and the features in the embodiments may be combined with each other without conflict.

### Embodiment 1

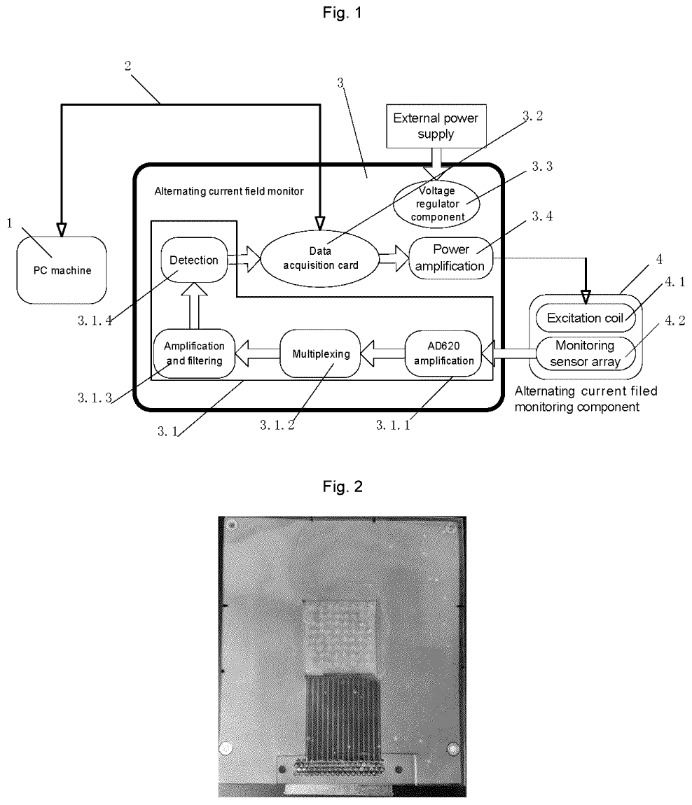

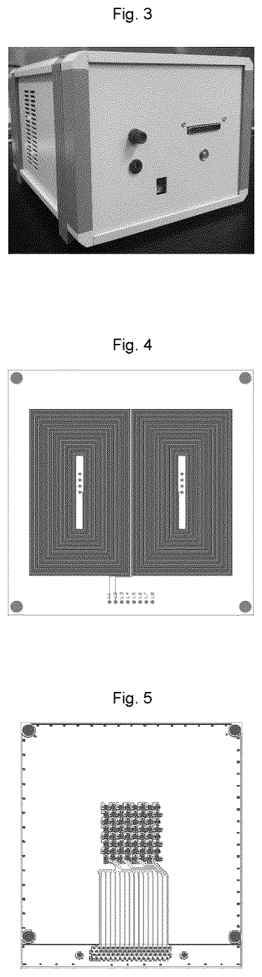

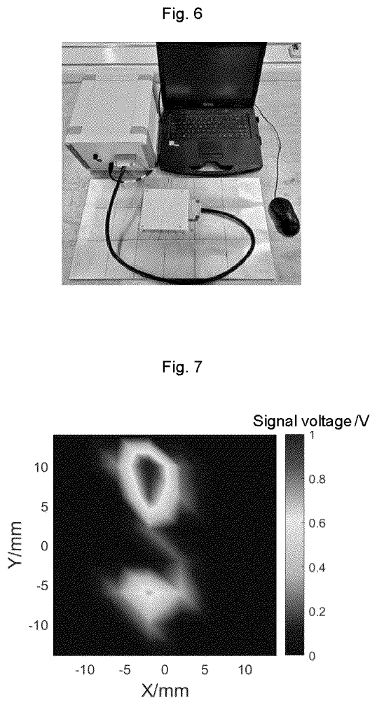

The embodiments of the present disclosure provide a visual monitoring system of crack propagation of an underwater structure based on an alternating current field, which mainly includes: a sensor component for monitoring flexible alternating current magnetic field 4 closely attached to a monitored surface, an alternating current field monitor 3, a USB data cable 2, and a computer 1, the sensor component for monitoring flexible alternating current magnetic field 4 including a flexible PCB excitation component 4.1 and a flexible monitoring sensor array 4.2, the alternating current field monitor 3 including a signal conditioning component 3.1, a signal acquisition component 3.2, a power amplifier component 3.3, and a voltage regulator component 3.4, and the computer 1 is connected with the signal acquisition component 3.2 in the alternating current field monitor 3 through the USB data cable 2, as shown in FIG. 1.

The flexible PCB excitation component 4.1 adopts two layers of double rectangular sensor coils printed on a flexible substrate, as shown in FIG. 4. The flexible substrate may be conveniently attached for monitoring of cracks at underwater key nodes, which solves the shortcomings that an alternating current field three-dimensional structure is not prone to installation and attachment. The double rectangular coils are loaded with excitation signals in different directions respectively, two excitation coils in different directions may generate vortex fields in different directions on the structure surface, and a uniform field is formed in the center area of the vortex field. When the crack is in the uniform field, the current disturbance is caused, which further causes the distortion of the surrounding magnetic field. The flexible monitoring sensor array 4.2 includes a flexible planar PCB component and 8 rows and 8 columns of sensor coils fixed thereto. The distorted magnetic field in the uniform current area is picked up by the sensor coil, and the area type monitoring area may be formed by the array sensor. The distorted magnetic field image in the monitoring area may be acquired by linear interpolation, and the visual imaging monitoring of the cracks at the key nodes is realized. The outer diameter of the sensor coil is 2 mm, the inner diameter is 0.5 mm, the number of turns of the sensor coil is 500, the axis of the sensor coil is perpendicular to the planar PCB, and the center distance between the sensor coils is 4 mm, as shown in FIG. 5. The sensor coil may be replaced by magnetic field sensors such as Tunnel Magneto Resistance (TMR), Anisotropy of Magneto Resistance (AMR), Hall, etc.

The voltage regulator component 3.3 is connected with the signal conditioning component 3.1, the signal acquisition component 3.2 and the power amplifier component 3.4 after regulating the voltage of an external DC power supply, the flexible excitation component 4.1 is connected with an output end of the power amplifier component 3.4, and an input end of the power amplifier component 3.4 is connected with an analog signal output end of the signal acquisition component 3.2. The signal acquisition component may generate a sinusoidal excitation signal, and the excitation signal is loaded into the double rectangular coils of the flexible excitation component after power amplification. The loading method is that a clockwise current is generated in the rectangular coil at one side and a counterclockwise current is generated in the rectangular coil at the other side, so that the rectangular coils of the flexible excitation component are loaded with currents in different directions.

The signal conditioning component 3.1 includes an AD620 differential amplifier component 3.1.1, a multiplexing component 3.1.2, an amplification and filtering component 3.1.3, and a wave detection component 3.1.4. An input end of the AD620 differential amplifier component 3.1.1 is connected with the flexible monitoring sensor coil 4.2. The multiplexing component 3.1.2 is designed with an ADG1607 chip, the amplification and filtering component combines second-order low-pass and first-order high-pass active filters to form a band-pass filter, and the detector component is designed for a diode detection circuit. A signal input end of the multiplexing component 3.1.2 is connected with a signal output end of the AD620 differential amplifier component 3.1.1, a control signal input end of the multiplexing component 3.1.2 is connected with a digital signal output end of the signal acquisition component 3.2, a signal output end of the multiplexing component 3.1.2 is connected with a signal input end of the amplification and filtering component 3.1.3, a signal output end of the amplification and filtering component 3.1.3 is connected with a signal input end of the wave detection component 3.1.4, and a signal output end of the wave detection component 3.1.4 is connected with an analog signal input end of the signal acquisition component 3.2.

The sensor coil picks up a weak distorted magnetic field in the uniform current area, which is amplified by the AD620 and then input to a multiplexer. The multiplexer may solve the problem of signal processing of multiple monitoring channels and sensor coil arrays. A set of hardware processing system may be used to complete the processing of multi-array signals. A control signal of the multiplexed signal is digitally controlled by the pulse of the acquisition card to solve the problem of time sequence control of multi-channel signal multiplexing and multi-channel acquisition.

The multiplexed signal enters the detection circuit after passing through the amplification and filtering component, and changes a sinusoidal response signal into an amplitude signal, and the detection signal is acquired by the acquisition card. After the acquisition is completed, the signal is transmitted to internal software of the computer for processing. Since the computer is connected with the acquisition card, the computer software may control the pulse of the acquisition card to trigger multiplexing, so as to realize the accurate separation of multi-channel signals, and achieve the recovery of the multi-channel signals. According to recovery results of the multi-array sensor signals, the internal software of the computer uses the linear interpolation of the amplitude signal to present the distorted magnetic field image of the monitoring area, and may image a visual monitoring image when the crack initiates or propagates, as shown in FIG. 7.

The embodiment has the following beneficial effects that: the flexible monitoring sensor component may adapt to the close attachment of the key nodes of the structure; the sensor arrays are arranged in a planar matrix, which may realize the crack monitoring in a certain area, the crack propagation endpoint and edge images may be displayed by a little processing of the monitoring signal, which gets rid of the tedious scanning of conventional ACFM opposite area detection, and has high accuracy and good real-time performance, and the long-term, real-time and fixed-point visual monitoring of crack propagation may be achieved without removing attachments and coatings, which provides accurate data support for the monitoring, evaluation and life prediction of corrosion cracks of the marine structures.

### Embodiment 2

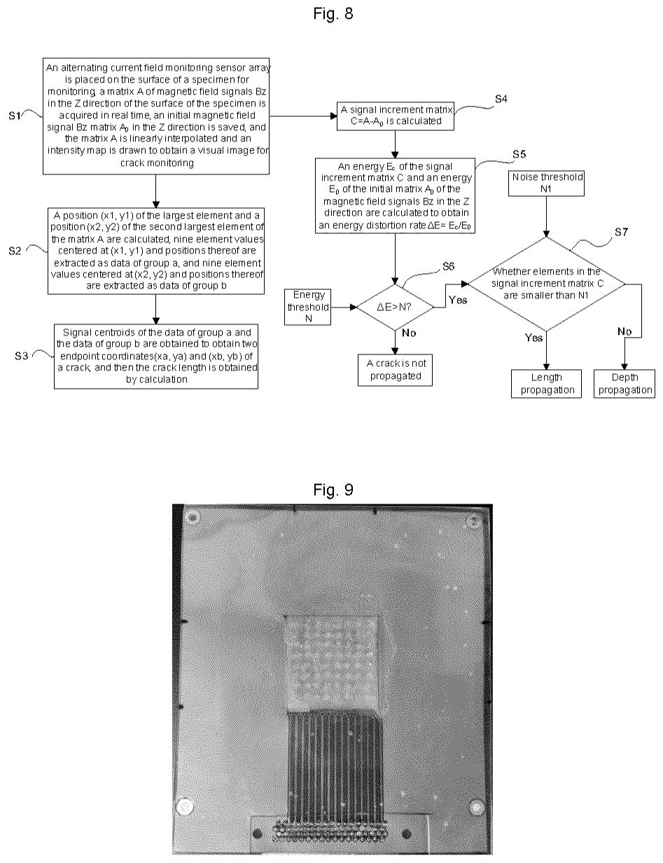

The computer in the above system executes a defect on-line intelligent determination and classification recognition method based on an ACFM technology, as shown in FIG. 8, the method may include the following operations.

At S1, a uniform induced current is generated on the surface of a specimen through a PCB excitation component to cause a distortion of a spatial magnetic field, a flexible monitoring sensor array composed of m rows and n columns of coils is placed on the surface of the specimen to extract a matrix

$$A 0 = [ \begin{matrix}Bz {0}_{11} & ⋯ & Bz \text{?} \\ ⋮ & ⋱ & ⋮ \\ Bz {0}_{m 1} & ⋯ & Bz \text{?}\end{matrix} ]$$

$$\text{?} \text{indicates text missing or illegible when filed}$$

of current magnetic field signals Bz0 in the Z direction at a initial moment of a monitoring area, a matrix

$$A = [ \begin{matrix}{Bz}_{11} & \text{?} & B \text{?} \\ ⋮ & ⋱ & ⋮ \\ {Bz}_{m 1} & ⋯ & B \text{?}\end{matrix} ]$$

$$\text{?} \text{indicates text missing or illegible when filed}$$

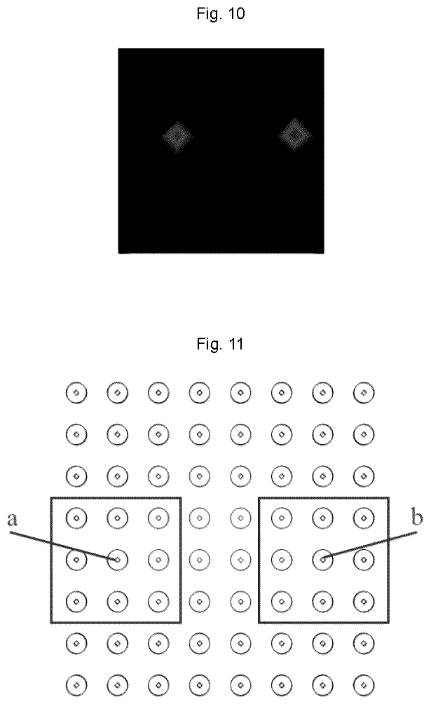

of real-time magnetic field signals Bz in the Z direction of the surface of the specimen is acquired in real time over time, the matrix A is linearly interpolated and an intensity map is drawn to obtain a visual image for monitoring of cracks at key nodes of a structure:
a depth propagation crack with the length of 16 mm on the surface of a specimen is monitored by using an alternating current field monitoring sensor array as shown in FIG. 9, a matrix A of magnetic field signals Bz in the Z direction of the surface of the specimen is acquired in real time and an initial matrix A0 of magnetic field signals Bz in the Z direction is saved, and a computer performs linear interpolation on the matrix A of the magnetic field signals Bz in the Z direction and draws an intensity map to obtain a structure crack monitoring image shown in FIG. 10. Real-time imaging and visual monitoring of cracks on the structure surface may be effectively realized. Elements of the matrix A are as follows:

| | | | | | | | |
|---|---|---|---|---|---|---|---|
| 0.028 | 0.028 | 0.058 | 0.016 | 0.156 | 0.068 | 0.015 | 0.004 |
| 0.026 | 0.022 | 0.07 | 0.267 | 1.085 | 0.243 | 0.058 | 0.04 |
| 0.009 | 0.006 | 0.043 | 0.224 | 0.506 | 0.166 | 0.063 | 0.021 |
| 0.021 | 0.027 | 0.022 | 0.039 | 0.015 | 0.007 | 0.018 | 0.007 |
| 0.013 | 0.017 | 0.001 | 0.136 | 0.389 | 0.113 | 0.04 | 0.012 |
| 0.022 | 0.017 | 0.027 | 0.237 | 1.095 | 0.196 | 0.027 | 0.002 |
| 0.021 | 0.02 | 0.003 | 0.073 | 0.182 | 0.029 | 0.034 | 0.003 |
| 0.045 | 0.037 | 0.045 | 0.029 | 0.014 | 0.024 | 0.015 | 0.028 |

Elements of the matrix A0 are as follows:

| | | | | | | | |
|---|---|---|---|---|---|---|---|
| 0.016 | 0 | 0.011 | 0.011 | 0.069 | 0.03 | 0.004 | 0.005 |
| 0.009 | 0.012 | 0.006 | 0.097 | 0.389 | 0.089 | 0.01 | 0.002 |
| 0.008 | 0.007 | 0.009 | 0.036 | 0.054 | 0.024 | 0.011 | 0.005 |
| 0.01 | 0.004 | 0.009 | 0.005 | 0.018 | 0.018 | 0.013 | 0.006 |
| 0.012 | 0.007 | 0.001 | 0.026 | 0.073 | 0.011 | 0.032 | 0.015 |
| 0.017 | 0.017 | 0 | 0.065 | 0.36 | 0.059 | 0.007 | 0.002 |
| 0 | 0.003 | 0 | 0.028 | 0.062 | 0.017 | 0.021 | 0.014 |
| 0.005 | 0 | 0.001 | 0.007 | 0.014 | 0.01 | 0.003 | 0.012 |

At S2, a position (x1, y1) of a largest element and a position (x2, y2) of a second largest element of the matrix A are obtained, p×q element values centered at (x1, y1) and positions thereof are extracted as data of group a, and nine element values centered at (x2, y2) and positions thereof are extracted as data of group b:
a position (16, 4) of a largest element and a position (16, 20) of a second largest element of the matrix A of the magnetic field signals Bz in the Z direction are obtained, as shown in FIG. 11, nine element values centered at (16, 4) and positions thereof are extracted as data of group a, and nine element values centered at (16, 20) and positions thereof are extracted as data of group b.

At S3, signal centroids of the data of the group a and the data of the group b are obtained respectively according to formulas

$$\overline{x} = \frac{\sum xi \times Bz}{\sum Bz} and \overline{y} = \frac{\sum yi \times Bz}{\sum Bz} .$$

Xi is X-coordinate positions of nine elements, yi is Y-coordinate positions of nine elements, two endpoint coordinates (xa, ya) and (xb, yb) of a crack are obtained, and length of the crack is calculated by a distance between the two endpoint coordinates:
signal centroids of the data of the group a and the data of the group b are obtained respectively according to formulas

$$\overline{x} = \frac{\sum xi \times Bz}{\sum Bz} and \overline{y} = \frac{\sum yi \times Bz}{\sum Bz}$$

to obtain two endpoint coordinates (15.966, 4.961) and (15.824, 19.422) of a crack, the crack length of 14.462 mm is further obtained by calculation, and the quantitative evaluation of the crack length is realized on the basis of real-time imaging.

At S4, a signal increment matrix

$$C = [ \begin{matrix}{dBz}_{11} & ⋯ & dB \text{?} \\ ⋮ & ⋱ & ⋮ \\ {dBz}_{m 1} & ⋯ & dB \text{?}\end{matrix} ]$$

$$\text{?} \text{indicates text missing or illegible when filed}$$

is obtained by subtracting the matrix A0 from the matrix A:
a signal increment matrix C is obtained by subtracting the matrix A0 from the matrix A, and elements of the signal increment matrix C are as follows:

| | | | | | | | |
|---|---|---|---|---|---|---|---|
| 0.012 | 0.028 | 0.047 | 0.005 | 0.087 | 0.038 | 0.011 | −0.001 |
| 0.017 | 0.01 | 0.064 | 0.17 | 0.696 | 0.1254 | 0.048 | 0.038 |
| 0.001 | −0.001 | 0.034 | 0.188 | 0.452 | 0.142 | 0.052 | 0.016 |
| 0.011 | 0.023 | 0.013 | 0.034 | −0.003 | −0.011 | 0.005 | 0.001 |
| 0.001 | 0.01 | 0 | 0.11 | 0.316 | 0.102 | 0.008 | −0.003 |
| 0.005 | 0 | 0.027 | 0.172 | 0.735 | 0.137 | 0.02 | 0 |
| 0.021 | 0.017 | 0.003 | 0.045 | 0.12 | 0.012 | 0.013 | −0.011 |
| 0.04 | 0.037 | 0.044 | 0.022 | 0 | 0.014 | 0.012 | 0.016 |

At S5, an energy value E0 of the matrix A0 and an energy value Ec of the signal increment matrix C are obtained according to a formula

$${E}_{dBz} = {\sum }_{j = 1}^{m \times n} dBz \text{?} .$$

$$\text{?} \text{indicates text missing or illegible when filed}$$

and a ratio of Ec to E0 is calculated to obtain an energy distortion rate ΔE:
an energy value E0=0.333 of the matrix A0 and an energy value Ec=1.559 of the signal increment matrix C are obtained according to a formula

$${E}_{dBz} = {\sum }_{j = 1}^{m \times n} dBz \text{?} .$$

$$\text{?} \text{indicates text missing or illegible when filed}$$

and a ratio of Ec to E0 is calculated to obtain an energy distortion rate ΔE=1.559/0.333=4683.

At SG, the energy distortion rate ΔE is compared with a set energy threshold N, in a case that ΔE>N, the crack has propagated, in a case that Δε≤N, determined that the crack has not propagated, and S7 is entered:
the energy distortion rate ΔE is compared with a set energy threshold N=0.5, and it is apparent that ΔE>N means that the crack has propagated. The above step may realize the determination and autonomous prediction of crack propagation, which has important practical significance in the aspect of early warning of crack propagation of the key nodes of the underwater structure. S7 is entered on the basis of determining the crack propagation.

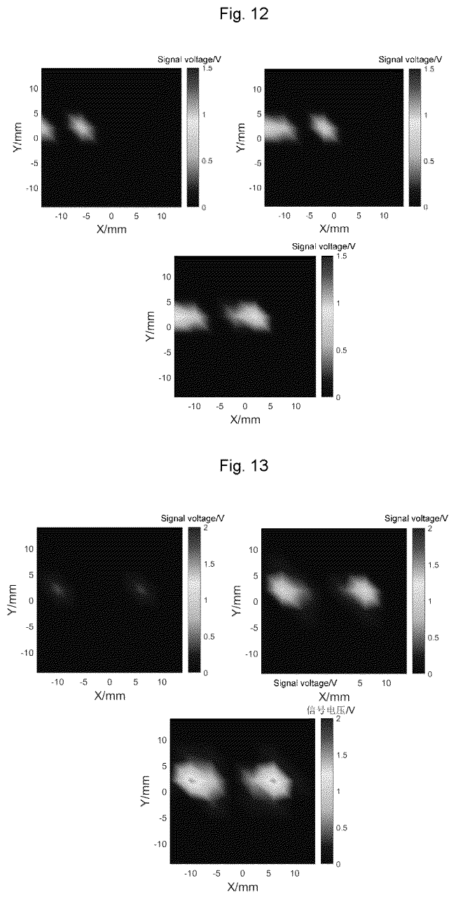

At S7, the elements in the signal increment matrix C are compared with a set noise threshold N1, and in a case that the elements in the signal increment matrix C<N1, the crack is in length propagation, in a case that the elements in the signal increment matrix C≥N1, the crack is in depth propagation:
if elements in the signal increment matrix C are smaller than a preset noise threshold N1=−0.2, it is apparent that no element in the matrix C is smaller than −0.2 in S4, and the crack is in depth propagation, as shown in FIG. 12. The crack length propagation may be determined in another embodiment, as shown in FIG. 13. The crack propagation type is further clarified on the basis of the above determination of crack propagation. The above method may not only predict the crack propagation, further clarify the crack propagation type, but provide an effective method for accurate and quantitative monitoring of the cracks at the key nodes of the underwater structure.

### Embodiment 3

The embodiments of the present disclosure provide a defect on-line intelligent determination and classification recognition method based on an ACFM technology, as shown in FIG. 8, which includes the following operations.

At S1, a uniform induced current is generated on the surface of a specimen through a PCB excitation component to cause a distortion of a spatial magnetic field, a flexible monitoring sensor array composed of m rows and n columns of coils is placed on the surface of the specimen to extract a matrix

$$A 0 = [ \begin{matrix}Bz {0}_{11} & ⋯ & Bz \text{?} \\ ⋮ & ⋱ & ⋮ \\ Bz {0}_{m 1} & ⋯ & Bz \text{?}\end{matrix} ]$$

$$\text{?} \text{indicates text missing or illegible when filed}$$

of current magnetic field signals Bz0 in the Z direction at a initial moment of a monitoring area, a matrix

$$A = [ \begin{matrix}{Bz}_{11} & ⋯ & B \text{?} \\ ⋮ & ⋱ & ⋮ \\ {Bz}_{m 1} & ⋯ & B \text{?}\end{matrix} ]$$

$$\text{?} \text{indicates text missing or illegible when filed}$$

of real-time magnetic field signals Bz in the Z direction of the surface of the specimen is acquired in real time over time, the matrix A is linearly interpolated and an intensity map is drawn to obtain a visual image for monitoring of cracks at key nodes of a structure:
a depth propagation crack with the length of 16 mm on the surface of a specimen is monitored by using an alternating current field monitoring sensor array as shown in FIG. 9, a matrix A of magnetic field signals Bz in the Z direction of the surface of the specimen is acquired in real time and an initial matrix A0 of magnetic field signals Bz in the Z direction is saved, and a computer performs linear interpolation on the matrix A of the magnetic field signals Bz in the Z direction and draws an intensity map to obtain a structure crack monitoring image shown in FIG. 10, which may effectively realize real-time imaging and visual monitoring of cracks on the structure surface. Elements of the matrix A are as follows:

| | | | | | | | |
|---|---|---|---|---|---|---|---|
| 0.028 | 0.028 | 0.058 | 0.016 | 0.156 | 0.068 | 0.015 | 0.004 |
| 0.026 | 0.022 | 0.07 | 0.267 | 1.085 | 0.243 | 0.058 | 0.04 |
| 0.009 | 0.006 | 0.043 | 0.224 | 0.506 | 0.166 | 0.063 | 0.021 |
| 0.021 | 0.027 | 0.022 | 0.039 | 0.015 | 0.007 | 0.018 | 0.007 |
| 0.013 | 0.017 | 0.001 | 0.136 | 0.389 | 0.113 | 0.04 | 0.012 |
| 0.022 | 0.017 | 0.027 | 0.237 | 1.095 | 0.196 | 0.027 | 0.002 |
| 0.021 | 0.02 | 0.003 | 0.073 | 0.182 | 0.029 | 0.034 | 0.003 |
| 0.045 | 0.037 | 0.045 | 0.029 | 0.014 | 0.024 | 0.015 | 0.028 |

Elements of the matrix AD are as follows:

| | | | | | | | |
|---|---|---|---|---|---|---|---|
| 0.016 | 0 | 0.011 | 0.011 | 0.069 | 0.03 | 0.004 | 0.005 |
| 0.009 | 0.012 | 0.006 | 0.097 | 0.389 | 0.089 | 0.01 | 0.002 |
| 0.008 | 0.007 | 0.009 | 0.036 | 0.054 | 0.024 | 0.011 | 0.005 |
| 0.01 | 0.004 | 0.009 | 0.005 | 0.018 | 0.018 | 0.013 | 0.006 |
| 0.012 | 0.007 | 0.001 | 0.026 | 0.073 | 0.011 | 0.032 | 0.015 |
| 0.017 | 0.017 | 0 | 0.065 | 0.36 | 0.059 | 0.007 | 0.002 |
| 0 | 0.003 | 0 | 0.028 | 0.062 | 0.017 | 0.021 | 0.014 |
| 0.005 | 0 | 0.001 | 0.007 | 0.014 | 0.01 | 0.003 | 0.012 |

At S2, a position (x1, y1) of a largest element and a position (x2, y2) of a second largest element of the matrix A are obtained, p×q element values centered at (x1, y1) and positions thereof are extracted as data of group a, and nine element values centered at (x2, y2) and positions thereof are extracted as data of group b:
a position (16, 4) of a largest element and a position (16, 20) of a second largest element of the matrix A of the magnetic field signals Bz in the Z direction are obtained, as shown in FIG. 11, nine element values centered at (16, 4) and positions thereof are extracted as data of group a, and nine element values centered at (16, 20) and positions thereof are extracted as data of group b.

At S3, signal centroids of the data of the group a and the data of the group b are obtained respectively according to formulas

$$\overline{x} = \frac{\sum xi \times Bz}{\sum Bz} and \overline{y} = \frac{\sum yi \times Bz}{\sum Bz} ,$$

Xi is X-coordinate positions of nine elements, yi is Y-coordinate positions of nine elements, two endpoint coordinates (xa, ya) and (xb, yb) of a crack are obtained, and length of the crack is calculated by a distance between the two endpoint coordinates:
signal centroids of the data of the group a and the data of the group b are obtained respectively according to formulas

$$\overline{x} = \frac{\sum xi \times Bz}{\sum Bz} and \overline{y} = \frac{\sum yi \times Bz}{\sum Bz} ,$$

to obtain two endpoint coordinates (15.956, 4.961) and (15.824, 19.422) of a crack, the crack length of 14.462 mm is further obtained by calculation, and the quantitative evaluation of the crack length is realized on the basis of real-time imaging.

At S4, a signal increment matrix

$$C = [ \begin{matrix}{dBz}_{11} & … & {dBz}_{1 n} \\ ⋮ & ⋱ & ⋮ \\ {dBz}_{m 1} & … & {dBz}_{mn}\end{matrix} ]$$

is obtained by subtracting the matrix A0 from the matrix A:
a signal increment matrix C is obtained by subtracting the matrix A0 from the matrix A, and elements of the signal increment matrix C are as follows:

| | | | | | | | |
|---|---|---|---|---|---|---|---|
| 0.012 | 0.028 | 0.047 | 0.005 | 0.087 | 0.038 | 0.011 | −0.001 |
| 0.017 | 0.01 | 0.064 | 0.17 | 0.696 | 0.154 | 0.048 | 0.038 |
| 0.001 | −0.001 | 0.034 | 0.188 | 0.452 | 0.142 | 0.052 | 0.016 |
| 0.011 | 0.023 | 0.013 | 0.034 | −0.003 | −0.011 | 0.005 | 0.001 |
| 0.001 | 0.01 | 0 | 0.11 | 0.316 | 0.102 | 0.008 | −0.003 |
| 0.005 | 0 | 0.027 | 0.172 | 0.735 | 0.137 | 0.02 | 0 |
| 0.021 | 0.017 | 0.003 | 0.045 | 0.12 | 0.012 | 0.013 | −0.011 |
| 0.04 | 0.037 | 0.044 | 0.022 | 0 | 0.014 | 0.012 | 0.016 |

At S5, an energy value E0 of the matrix A0 and an energy value Ec of the signal increment matrix C are obtained according to a formula

$${E}_{dBz} = {\sum }_{j = 1}^{m \times n} {dBz}_{j}^{2} ,$$

and a ratio of Ec to E0 is calculated to obtain an energy distortion rate ΔE:
an energy value E0=0.333 of the matrix A0 and an energy value Ec=1.559 of the signal increment matrix C are obtained according to a formula

$${E}_{dBz} = {\sum }_{j = 1}^{m \times n} {dBz}_{j}^{2} ,$$

and a ratio of Ec to E0 is calculated to obtain an energy distortion rate ΔE=1.559/0.333=4.683.

At S6, the energy distortion rate ΔE is compared with a set energy threshold N, in a case that ΔE>N, the crack has propagated, in a case that Δε≤N, determined that the crack has not propagated, and S7 is entered:
the energy distortion rate ΔE is compared with a set energy threshold N=0.5, and it is apparent that ΔE>N means that the crack has propagated. The above step may realize the determination and autonomous prediction of crack propagation, which has important practical significance in the aspect of early warning of crack propagation of the key nodes of the underwater structure. S7 is entered on the basis of determining the crack propagation.

At S7, the elements in the signal increment matrix C are compared with a set noise threshold N1, and in a case that the elements in the signal increment matrix C<N1, the crack is in length propagation, in a case that the elements in the signal increment matrix C≥N1, the crack is in depth propagation:
if element in the signal increment matrix C are smaller than a preset noise threshold N1=−0.2, it is apparent that no element in the matrix C is smaller than −0.2 in S4, and the crack is in depth propagation, as shown in FIG. 12. The crack length propagation may be determined in another embodiment, as shown in FIG. 13. The crack propagation type is further clarified on the basis of the above determination of crack propagation. The above method may not only predict the crack propagation, further clarify the crack propagation type, but provide an effective method for accurate and quantitative monitoring of the cracks at the key nodes of the underwater structure.

The embodiment has the following beneficial effects that: real-time imaging and visual monitoring of the cracks in a certain area may be realized through the monitoring data processing, the determination of the crack break point and the evaluation of the crack length may be realized, at the same time, the determination of whether the crack is propagated and the determination of the propagation type may also be realized with high accuracy and good real-time performance, and the long-term, real-time and fixed-point visual monitoring of crack propagation may be achieved without removing attachments and coatings, which provides accurate data support for the monitoring, evaluation and life prediction of corrosion cracks of the marine structures.

According to the structure crack visual monitoring and evaluation method based on the ACFM technology provided by the present disclosure, an alternating current field monitoring sensor array is placed on the surface of the specimen for monitoring, the matrix A of the magnetic field signals Bz in the Z direction of the surface of the specimen is acquired in real time and the initial matrix A0 of the magnetic field signals Bz in the Z direction is saved, and the matrix A of the magnetic field signals Bz in the Z direction is linearly interpolated and the intensity map is drawn to obtain the visual image for structure crack monitoring. The position (x1, y1) of the largest element and the position (x2, y2) of the second largest element of the matrix A of the magnetic field signals Bz in the Z direction are obtained, nine element values centered at (x1, y1) and positions thereof are extracted as the data of group a, and nine element values centered at (x2, y2) and positions thereof are extracted as the data of group b. The signal centroids of the data of group a and the data of group b are obtained respectively to obtain two endpoint coordinates (xa, ya) and (xb, yb) of the crack, and then the crack length is calculated. The signal increment matrix C is obtained by subtracting the initial matrix A0 of the magnetic field signals Bz in the Z direction from the matrix A of the magnetic field signals Bz in the Z direction. The energy value E0 of the matrix A0 of the magnetic field signals Bz in the Z direction and the energy value Ec of the signal increment matrix C are obtained, and the ratio of Ec to E0 is calculated to obtain the energy distortion rate ΔE to be compared with the set energy threshold N, if ΔE>N, the crack has propagated. Further, if the elements in the signal increment matrix C are smaller than the noise threshold N1, the crack is in length propagation, otherwise in depth propagation. Finally, visual monitoring and evaluation of the structure cracks are realized.

According to the structure crack propagation visual monitoring hardware system based on the ACFM technology provided by the present disclosure, the coil is used to design and manufacture the alternating current field monitoring sensor array, the alternating current field monitoring sensor component is formed by packaging, the power amplifier component is designed to provide the excitation signal for the alternating current field monitoring sensor component, the AD620 differential amplifier component is designed to amplify the weak sensing signal, the multiplexing component is designed to realize time-sharing multiplexing of multiple sensing signals, the signal amplification and filtering component is designed to further amplify and filter the signal, the wave detection component is designed to convert an AC signal into a DC signal, and an NI acquisition card is used to realize the excitation signal generation, multiplexing control signal output and signal acquisition, and finally processing and acquisition of visual monitoring signals for structure crack propagation are realized.

The above is only the specific implementation modes of the present disclosure and not intended to limit the scope of protection of the present disclosure. Any change or replacement that those skilled in the art may think of easily in the scope of technologies disclosed by the present disclosure shall fall within the scope of protection of the present disclosure. Therefore, the scope of protection of the present disclosure shall be subject to the scope of protection of the claims.

1. A visual monitoring system of crack propagation of an underwater structure based on an alternating current field, wherein the system comprises:
a sensor component for monitoring flexible alternating current magnetic field closely attached to a surface of a specimen, an alternating current field monitor, a Universal Serial Bus (USB) data cable, and a computer, the sensor component for monitoring flexible alternating current magnetic field comprising a flexible Printed Circuit Board (PCB) excitation component and a flexible monitoring sensor array, the alternating current field monitor comprising a signal conditioning component, a signal acquisition component, a power amplifier component, and a voltage regulator component, and the computer being connected with the signal acquisition component in the alternating current field monitor through the USB data cable.

2. The monitoring system as claimed in claim 1, wherein the flexible PCB excitation component adopts M (M≥1) layers of double rectangular sensor coils printed on a flexible substrate, the double rectangular sensor coils are loaded with excitation signals in different directions respectively, the flexible monitoring sensor array comprises a flexible planar PCB component and m rows and n columns of sensor coils fixed on the flexible planar PCB component, outer diameter of the sensor coil being D (D<10 mm), inner diameter being d (d<D), the number of turns of the sensor coil being N, axis of the sensor coil being perpendicular to the flexible planar PCB component, center distance between the two adjacent sensor coils being 3 mm-20 mm, and the sensor coil being replaced by a magnetic field sensor.

3. The monitoring system as claimed in claim 1, wherein the voltage regulator component is respectively connected with the signal conditioning component, the signal acquisition component, and the power amplifier component, the flexible PCB excitation component is connected with an output end of the power amplifier component, and an input end of the power amplifier component is connected with an analog signal output end of the signal acquisition component.

4. The monitoring system as claimed in claim 1, wherein the signal conditioning component comprises an AD620 differential amplifier component, a multiplexing component, an amplification and filtering component, and a wave detection component, a input end of the AD620 differential amplifier component being connected with the sensor coil, a signal input end of the multiplexing component being connected with a signal output end of the AD620 differential amplifier component, a control signal input end of the multiplexing component being connected with a digital signal output end of the signal acquisition component, a signal output end of the multiplexing component being connected with a signal input end of the amplification and filtering component, a signal output end of the amplification and filtering component being connected with a signal input end of the wave detection component, and a signal output end of the wave detection component being connected with an analog signal input end of the signal acquisition component.

5. The monitoring system as claimed in claim 1, wherein the computer executes:
generating a uniform induced current on the surface of the specimen through the PCB excitation component to cause a distortion of a spatial magnetic field, placing a flexible monitoring sensor array composed of m rows and n columns of the sensor coils on the surface of the specimen to acquire a matrix
$$A 0 = [ \begin{matrix}Bz {0}_{11} & … & Bz {0}_{1 n} \\ ⋮ & ⋱ & ⋮ \\ Bz {0}_{m 1} & … & Bz {0}_{mn}\end{matrix} ]$$
of current magnetic field signals Bz0 in the Z direction at a initial moment of a monitoring area, acquiring a matrix
$$A = [ \begin{matrix}{Bz}_{11} & … & {Bz}_{1 n} \\ ⋮ & ⋱ & ⋮ \\ {Bz}_{m 1} & … & {Bz}_{mn}\end{matrix} ]$$
of real-time magnetic field signals Bz in the Z direction of the surface of the specimen in real time over time, and linearly interpolating the matrix A and drawing a intensity map to obtain a visual image for monitoring of cracks at key no des of the underwater structure.

6. The monitoring system as claimed in claim 5, wherein the method further comprises:
obtaining a position (x1, y1) of a largest element and a position (x2, y2) of a second largest element of the matrix A, extracting p×q element values centered at (x1, y1) and positions thereof as data of group a, and extracting nine element values centered at (x2, y2) and positions thereof as data of group b.

7. The monitoring system as claimed in claim 6, wherein the method further comprises:
calculating signal centroids of the data of the group a and the data of the group b respectively according to formulas
$$\overline{x} = \frac{\sum xi \times Bz}{\sum Bz} and \overline{y} = \frac{\sum yi \times Bz}{\sum Bz} ,$$
xi being X-coordinate positions of nine elements, yi being Y-coordinate positions of nine elements, obtaining two endpoint coordinates (xa, ya) and (xb, yb) of a crack, and calculating length of the crack by a distance between the two endpoint coordinates.

8. The monitoring system as claimed in claim 5, wherein the method further comprises:
obtaining a signal increment matrix
$$C = [ \begin{matrix}{dBz}_{11} & … & {dBz}_{1 n} \\ ⋮ & ⋱ & ⋮ \\ {dBz}_{m 1} & … & {dBz}_{mn}\end{matrix} ]$$
by subtracting the matrix A0 from the matrix A.

9. The monitoring system as claimed in claim 8, wherein the method further comprises:
obtaining an energy value E0 of the matrix A0 and an energy value Ec of the signal increment matrix C according to a formula
$${E}_{dBz} = {\sum }_{j = 1}^{m \times n} {dBz}_{j}^{2} ,$$
and calculating a ratio of Ec to E0 to obtain an energy distortion rate ΔE.

10. The monitoring system as claimed in claim 9, wherein the method further comprises:
comparing the energy distortion rate ΔE with a set energy threshold N, in a case that ΔE>N, determining that the crack has propagated; and
in a case that ΔE≤N, determining that the crack has not propagated, and comparing elements in the signal increment matrix C with a set noise threshold N1, and in a case that the elements in the signal increment matrix C<N1, determining that the crack is in length propagation, in a case that the elements in the signal increment matrix C≥N1, determining that the crack is in depth propagation.

11. An alternating current field crack visual monitoring and evaluation method, comprising:
generating an uniform induced current on a surface of a specimen through a Printed Circuit Board (PCB) excitation component to cause a distortion of a spatial magnetic field, placing a flexible monitoring sensor array composed of m rows and n columns of sensor coils on the surface of the specimen to acquire a matrix
$$A 0 = [ \begin{matrix}Bz {0}_{11} & … & Bz {0}_{1 n} \\ ⋮ & ⋱ & ⋮ \\ Bz {0}_{m 1} & … & Bz {0}_{mn}\end{matrix} ]$$
of current magnetic field signals Bz0 in the Z direction at a initial moment of a monitoring area, acquiring a matrix
$$A = [ \begin{matrix}{Bz}_{11} & … & {Bz}_{1 n} \\ ⋮ & ⋱ & ⋮ \\ {Bz}_{m 1} & … & {Bz}_{mn}\end{matrix} ]$$
of real-time magnetic field signals Bz in the Z direction of the surface of the specimen in real time over time, and linearly interpolating the matrix A and drawing an intensity map to obtain a visual image for monitoring of cracks at key nodes of the underwater structure.

12. The method as claimed in claim 11, comprising:
obtaining a position (x1, y1) of a largest element and a position (x2, y2) of a second largest element of the matrix A, extracting p×q element values centered at (x1, y1) and positions thereof as data of group a, and extracting nine element values centered at (x2, y2) and positions thereof as data of group b.

13. The method as claimed in claim 12, comprising:
obtaining signal centroids of the data of the group a and the data of the group b respectively according to formulas
$$\overline{x} = \frac{\sum xi \times Bz}{\sum Bz} and \overline{y} = \frac{\sum yi \times Bz}{\sum Bz} ,$$
Xi being X-coordinate positions of nine elements, yi being Y-coordinate positions of nine elements, obtaining two endpoint coordinates (xa, ya) and (xb, yb) of a crack, and calculating length of the crack by a distance between the two endpoint coordinates.

14. The method as claimed in claim 11, comprising-S4:
obtaining a signal increment matrix
$$C = [ \begin{matrix}{dBz}_{11} & … & {dBz}_{1 n} \\ ⋮ & ⋱ & ⋮ \\ {dBz}_{m 1} & … & {dBz}_{mn}\end{matrix} ]$$
by subtracting the matrix A0 from the matrix A.

15. The method as claimed in claim 14, comprising-S4:
obtaining an energy value E0 of the matrix A0 and an energy value Ec of the signal increment matrix C according to a formula
$${E}_{dBz} = {\sum }_{j = 1}^{m \times n} {dBz}_{j}^{2} ,$$
and calculating a ratio of Ec to E0 to obtain an energy distortion rate ΔE.

16. The method as claimed in claim 15, comprising:
comparing the energy distortion rate ΔE with a set energy threshold N, in a case that ΔE>N, determining that the crack has propagated; and
in a case that ΔE≤N, determining that the crack has not propagated, and comparing the elements in the signal increment matrix C with a set noise threshold N1, and in a case that the elements in the signal increment matrix C<N1, determining that the crack is in length propagation, in a case that the elements in the signal increment matrix C≥N1, determining that the crack is in depth propagation.
